(19) United States
(12) Patent Application Publication
(10) Pub. No.: US 2023/0095339 A1
(43) Pub. Date: Mar. 30, 2023

(54) AUGMENTED REALITY FOR EMERGENCY RESPONSE

(71) Applicant: University of Notre Dame du Lac, South Bend, IN (US)

(72) Inventors: Jane Cleland-Huang, South Bend, IN (US); Ankit Agrawal, South Bend, IN (US)

(21) Appl. No.: 17/936,648

(22) Filed: Sep. 29, 2022

Related U.S. Application Data
(60) Provisional application No. 63/250,193, filed on Sep. 29, 2021.

(51) Int. Cl. G06T 19/00; G06T 15/06; G06F 3/0488; G06V 20/17; G05D 1/00; G05D 1/10; B64C 39/02

(52) U.S. Cl. CPC G06T 19/006; G06T 15/06; G06F 3/0488; G06V 20/17; G05D 1/0038; G05D 1/104; B64C 39/024; G06T 2219/024; B64C 2201/126

(57) ABSTRACT

A method for sharing a point-of-interest across a plurality of video feeds from a plurality of optical imaging devices includes receiving an indication of the point-of-interest associated with a first video feed of the plurality of video feeds, the first video feed provided by a first optical imaging device of the plurality of optical imaging devices; determining a geo-location of an object associated with the point-of-interest; determining a position of a second optical imaging device relative to the determined geo-location of the point-of-interest; and overlaying the point-of-interest on a second video feed, the second video feed provided by the second optical imaging device.

### CROSS-REFERENCE TO RELATED APPLICATIONS

This application is a non-provisional application claiming priority from U.S. Provisional Application No. 63/250,193 filed on Sep. 29, 2021 and entitled “METHOD OF PERFORMING AUGMENTED REALITY DURING DRONE MISSIONS,” which is hereby incorporated by reference in its entireties.

### STATEMENT REGARDING FEDERALLY SPONSORED RESEARCH OR DEVELOPMENT

This invention was made with government support under grant CNS1931962 awarded by the National Science Foundation. The government has certain rights in the invention.

### FIELD OF THE DISCLOSURE

This disclosure generally relates to augmented reality, and specifically, augmented reality for emergency response.

### BACKGROUND

Augmented Reality (AR) generally refers to superimposing or otherwise overlaying virtual objects onto a user's view of a real-world space. This view may be what is directly in-front of the user (e.g., the user is wearing AR glasses through which the user can see the real world) or may be a video feed from a camera or other optical imaging device. In this way, AR typically provides a blend of real and virtual information for a user to utilize both in decision-making.

One popular example of AR is implemented in vehicles to assist with reverse-driving. Many vehicles come equipped with a back-up camera that turns on when the vehicle is in reverse. In addition, some vehicles then overlay tracks or another indicator that is based on a position of the vehicle's wheels and that shows a predicted trajectory of the vehicle when backing up. This enables a user to more accurately judge if they are on track to fit within a parking spot, or if they need to turn the wheels.

Technological advancements have enabled Uncrewed Aerial vehicles (UAVs) to evolve from manual to semi-autonomous to near fully autonomous operations. As a result, they have gained in popularity as surveillance, delivery, photography, and emergency rescue tools, with state of the art emergency response teams exploring the use of smart UAVs for public safety operations such as search and rescue, firefighting, surveillance, and disaster relief. While technological advances allow UAVs to operate independently, human supervision with timely interventions are still necessary to ensure their ethical and safe operations. Therefore, both humans and smart UAVs are required to work together as a Human-Agent Team (HAT) during emergency response. For example, a team of law enforcement officers could help catch a fleeing suspect by having officers monitor a UAV's video feed and relay details to officers in pursuit.

While AR has been employed for use with UAVs to address some of these concerns, there is an identifiable desire for improvements in the features in or associated with AR and UAVs, particularly in the sharing of information and positioning across multiple UAVs in a fleet.

### BRIEF DESCRIPTION OF THE DRAWINGS

FIG. 1 is a diagram of an example system for sharing an identified point-of-interest (POI) across multiple devices in accordance with the various examples disclosed herein.

FIG. 2 is a flow chart of an example implementation of the system in accordance with the various examples disclosed herein.

FIG. 3 is a flow chart illustrating an example method of sharing a point-of-interest (POI) across a plurality of video feeds from a plurality of optical imaging devices in accordance with the various examples disclosed herein.

FIG. 4 is a flow chart illustrating an example method 400 of tracking multiple objects in a physical three-dimensional space in accordance with the various examples disclosed herein.

FIG. 5 is a diagrammatic view of an example of a computing environment in accordance with the various examples disclosed herein.

The drawings accompanying and forming part of this specification are included to depict certain aspects of the invention. A clearer conception of the invention, and of the components and operation of systems provided with the invention, will become more readily apparent by referring to the exemplary, and therefore non-limiting, examples illustrated in the drawings, wherein like reference numbers (if they occur in more than one view) designate the same elements. The invention may be better understood by reference to one or more of these drawings in combination with the description presented herein.

### DETAILED DESCRIPTION

The following disclosure of example methods and apparatus is not intended to limit the scope of the disclosure to the precise form or forms detailed herein. Instead, the following is intended to be illustrative so that others may follow its teachings.

The social communication challenge presented here is to ensure a coherent interpretation of the situation among emergency responders and public safety professionals. Information communicated over the radio suffers from noise in signals, lacks visualization, and is difficult to persist for later analysis. Organizational communication challenges also arise due to information gaps between primary decision-makers such as on-site first responders, remote emergency operations centers (EOC), and local governments when planning emergency responses. Therefore, the social and organizational challenges of communication necessitate improving the way emergency response teams consume and share information during emergency response.

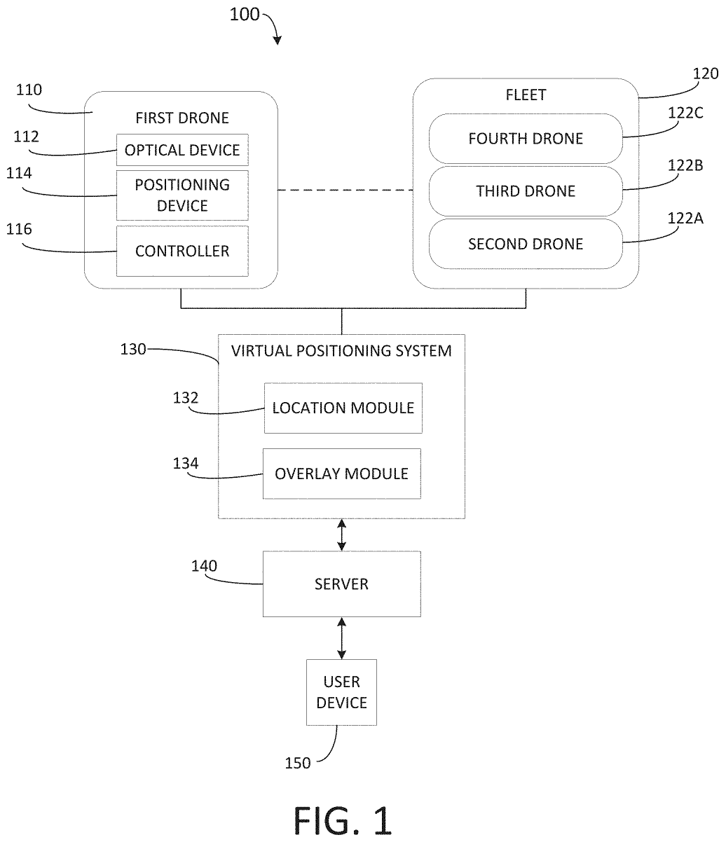

FIG. 1 is a diagram of an example system 100 for sharing an identified point-of-interest (POI) across multiple devices. As shown in FIG. 1, the system 100 includes a first drone 110, a fleet 120, and a virtual positioning system 130 that includes one or more functional modules 132 and 134 embodied in hardware, firmware, and/or software. In an example, the functional modules 132 and 134 of the virtual positioning system 130 are embodied in a processor and a memory (i.e., a non-transitory, computer-readable medium) storing instructions that, when executed by the processor, cause the processor to perform the functionality of one or more of the functional modules and/or other functionality of this disclosure.

In this example, the first drone 110 and the fleet 120 are in communication with the virtual positioning system 130, which is in turn in communication with the user device 150 via the server 140. As such, each of the first drone 110, the fleet 120, the virtual positioning system 130, and the user device 150 are part of a communication network which may be internet-based and may include one or more wireless, one or more wired, and/or other suitable network connection(s). For example, the first drone 110 and the fleet 120 may be connected wirelessly to the virtual positioning system 130, and the virtual positioning system 130 may have a wired connection to the user device 150 via the server 140. As shown, the first drone 110 may also be in communication with the fleet 120.

The example first drone 110 is shown to include an optical device 112, a positioning device 114, and a controller 116. The optical device 112 is, in this example, any suitable device or apparatus that is capable of capturing an image, converting the image to a signal, and transmitting that signal to a connected device (e.g., the virtual positioning system 130). As such, the optical device 112 may include a camera or a visual sensor (such as for instance an infrared sensor) configured to capture the image and may include a processor configured to convert the image and a transmitter or other transceiver to transmit the resultant signal. The positioning device 114 is, in the illustrated example, any device or apparatus that is capable of determining and transmitting a position of the first drone 110. This position data may include a geolocation of the first drone 110, an elevation of the first drone 110, a pitch of the first drone 110, and/or other suitable position information. In some examples, the position data may further include a speed, velocity, and/or direction-of-travel of the first drone 110 as desired. As such, the positioning device 114 may include a Global Positioning System (GPS), Radio Frequency Identification (RFID) tracking system, accelerometer, pressure sensor, elevation sensor, temperature sensor, velocity sensor, vibration and tilt sensor, or any other relevant sensor. The positioning device 114 is also configured to determine and provide location and other status data of the optical device 112. For example, if the optical device 112 operates and moves independently of the first drone 110, the positioning device 114 determines the position, yaw, tilt, etc. for the optical device 112.

In this illustrated example, the controller 116 is electrically coupled to the optical device 112 and to the positioning device 114 to control operations of the optical device 112 and the positioning device 114 and to direct output from both the optical device 112 and the positioning device 114 to external components (e.g., virtual positioning system 130). For example, the controller 116 may issue commands to the optical device 112 to capture images in a particular direction or with a particular focus. The controller 116 may also receive signals from the optical device 112 (either raw video signal or converted and processed video signals) and direct the signals to an external component. In some examples, the controller 116 includes a dedicated control chip (for example, a microcontroller unit (MCU)). The controller 116 may also control the circuit state of the entire first drone 110 (including a motor and related components) and achieve various functions such as acceleration, turning, etc.

The example controller 116 is also configured to process location data from the positioning device 114 to a type of data that can be utilized by the virtual positioning system 130. For instance, if the positioning device 114 provides GPS location data, the controller 116 converts the GPS location data to Earth-Centered, Earth-Fixed (ECEF) Cartesian coordinate system.

As shown, the example fleet 120 includes a second drone 122A, a third drone 122B, and a fourth drone 112C. Each drone in the fleet 120 may be substantially identical to the first drone 110, such that each of the second drone 122A, the third drone 122B, and the fourth drone 112C include components analogous to the optical device 112, the positioning device 114, and the controller 116. As such, each of the second drone 122A, the third drone 122B, and the fourth drone 112C may perform the functions disclosed herein with regard to the first drone 110. Although only an additional three drones are shown in the fleet 120, it is contemplated that any number of drones may be included in the fleet 120. Furthermore, although the term “drone” is used throughout, any type of uncrewed or otherwise remotely-controlled vehicle, device, or cyber physical system should be contemplated as included within the scope of this disclosure.

Each drone in the fleet 120 may communicate with each other as well as with the first drone 110. This communication may include relaying a position of a drone to the other drones to avoid crashes or other interferences due to proximity. The communication may further include a speed or velocity of a drone to the other drones in order to coordinate movement. For example, if the fleet 120 is being deployed to sweep an area, the drones in the fleet 120 can communicate to maintain a similar speed and, therefore, a more unbroken line.

The functional modules 132, 134 include a location module 132 that is configured to receive location data from one or more drones (e.g., first drone 110, second drone 122A, third drone 122B, fourth drone 122C, etc.), establish a virtual space, and determine markers for each of the one or more drones based on the received location data. The virtual space may be established to correspond with a defined area in the real-world. As such, the virtual space may include topography associated with the defined area, as well as identified geographic POIs. These geographic POIs could include landmarks, stores, roads, highways, intersections, etc. and may be pulled from a database of geographic POIs and correlated to the defined area. For example, the virtual positioning system 130 may, via the server 140, access a set of stored geographic POIs from an online search engine repository, or the virtual positioning system 130 may have a pre-filled database of stored geographic POIs.

In one example, the defined area is based on the received location data from the one or more drones, such that the defined area may be an area having a certain radius with the first drone 110 as a center-point. In another example, the defined area is pre-determined, such that the bounds of the defined area are received or entered prior to operation of the system 100. The pre-determined defined area may be entered into the user device 150 by a user who is able to select or set the bounds of the defined area (e.g., on a map).

In an example, the virtual space is correlated to the defined area by associating a geolocation of the defined area with stored data regarding various possible areas. In this example, the virtual positioning system 130 includes a database that stores geographic data about a relatively large swath of land or space, and the virtual positioning system 130 defines a base of the virtual space by looking up stored geographic data based on a geolocation of the defined area's center-point. In another example, the virtual space is correlated to the defined area by utilizing a visual learning model that extracts topographical and other information from a video feed. In this example, a drone (e.g., first drone 110) is deployed to fly over and capture images of the defined area. The virtual positioning system 130 then applies the visual learning model to review the captured images and extract the necessary data from the captured images. From there, the virtual positioning system 130 applies stored geographic POI data to enhance the virtual space with additional information.

Once the virtual space is established, the virtual positioning system 130 determines markers in the virtual space that correspond to the received locations of the one or more drones. As such, a location of each virtual marker in the virtual space is based on a geolocation of a drone in the defined area. In this way, a distance and relative position of each virtual marker relative to the other virtual markers is equivalent or consistent with the distance and relative position of each drone relative to the other virtual markers. In one example, the relative distances in the virtual space is one-to-one with the relative distances in the defined area, while in another example, the relative distances in the virtual space are smaller than those in the defined area, such that the virtual space is a relatively smaller scale than the defined area while maintaining the same relative distances between virtual markers, etc. Establishing a smaller virtual space could be advantageous for reducing a strain on the server 140 and/or reducing an amount of storage space occupied by the virtual positioning system 130.

The location module 132 sets initial positions for the virtual markers based on received geolocations of the drones as the virtual positioning system 130 initializes. The location module 132 then updates the virtual markers as updated geolocations are received, which serves to track each of the drones as the drones move. The updated geolocations may be requested by the location module 132 at various intervals (e.g., every second, every minute, etc.), or the updated geolocations may be autonomously sent by the drones at various intervals or based on a travel distance. For example, the location module 132 instructs the drones to send an updated geolocation when the drone travels a certain distance, so the location module 132 receives updated geolocation from the drone when the drone detects or determines that the drone has traveled the certain distance. Increasing the intervals would reduce processing requirements but would decrease the accuracy of the tracked markers, while decreasing the intervals would improve the accuracy at the cost of increased processing requirements. By continuing to update the positions of the virtual markers, the location module 132 tracks each of the drones throughout their flights.

The example functional modules 132, 134 include an overlay module 134 that is configured to receive an indication of a POI, mark the POI in the established virtual space, determine a location of the POI relative to the fleet 120, and render or display the POI on video feeds provided by the fleet 120. The indication may be received via the user device 150, which is configured to receive an interaction from a user and log that interaction as indicating a POI on a video feed. For example, the user device 150 may be touch-sensitive and, while displaying a video feed, may detect a user's touch. In another example, the user device 150 may be configured to have a user-controllable cursor and, while displaying a video feed, may detect an interaction from the cursor.

Once an interaction is detected, the video feed is analyzed to determine the object shown in the video feed associated with the user interaction. In one example, the frame of the video feed during with the user interaction is first detected is extracted as a still image, and a trained model is employed to analyze the still image to determine the pixels of the still image that define the indicated POI. The indicated POI may be an object, a person, a location, or any other thing that could be of interest to a drone pilot or emergency responder. The trained model may be a machine learning model that has been trained with images of various objects or people that could be expected to be a POI. From there, ray-tracing is used to determine a distance and direction of the indicated object relative to the source of the video feed (e.g., the optical device 112 of the first drone 110). An example formula for utilizing ray-tracing is provided below as formula (1):

$$[ {ECEF}_{POI} ] = [ \begin{matrix}{X}_{POI} \\ {Y}_{POI} \\ {Z}_{POI}\end{matrix} ] = [ \begin{matrix}- sin λ & - sin ϕ cos λ & cos ϕ cos λ \\ cos λ & - sin ϕ sin λ & cos ϕ sin λ \\ 0 & cos ϕ & sin ϕ\end{matrix} ] [ \begin{matrix}x \\ y \\ z\end{matrix} ] + [ \begin{matrix}{X}_{UAV} \\ {Y}_{UAV} \\ {Z}_{UAV}\end{matrix} ] \qquad ( 1 )$$

where ECEF_{POI} and X_{POI}, Y_{POI}, Z_{POI} are the ECEF coordinates for the POI, ϕ is the geographic raw latitude of the location of the first drone 110, A is the geographic raw longitude of the location of the first drone 110, x, y, z are the position of the POI relative to the position of the first drone 110, and X_{UAV}, Y_{UAV}, Z_{UAV} are the ECEF coordinates of the first drone 110.

Relying on the location module 132, the overlay module 134 then determines a position of the indicated POI based on the known position of the source of the video feed. For example, if the video feed on which the user indicated the POI is provided by the optical device 112 of the first drone 110, then the geolocation of the indicated POI is determined based on the geolocation of the first drone 110 at the time the user indicated the POI.

The indicated POI may also be based on a visual detection model embedded or loaded on the controller 116 of the first drone 110 that is trained to review the output of the optical device 112 and autonomously detect a POI. For example, the visual detection model is trained to recognize prone persons, so if a prone person is detected on the video feed from the first drone 110, the visual detection model indicates the pixels of the video feed that correspond to the prone person as the POI.

The determined geolocation of the indicated POI is then used to generate a virtual marker in the established virtual space. As such, the established virtual space now has a marker for each drone in the fleet 120 (including the first drone 110) and a marker for the indicated POI. Because the locations of the virtual markers in the virtual space are based on the geolocations of the respective devices or objects in the defined area in the real world, the relative distance and direction of each drone in the real world relative to the indicated POI can be determined using the virtual space.

In one example, the indicated POI is associated with a stationary object or person (e.g., a stranded vehicle, an injured hiker, etc.), such that the geolocation (and associated virtual marker) does not move. In another example, the indicated POI is associated with a moving object (e.g., fleeing suspect, person caught up in rapids, etc.), such that the geolocation (and associated virtual marker) moves. In this example, the changing geolocation of the indicated POI is tracked through the use of multiple video feeds. Because the virtual marker is tracked relative to every other virtual marker, if even a single video feed includes the indicated POI, then the relative location of the indicated POI is shared across every video feed. As such, it is not necessary that a single drone (e.g., the first drone 110) be tasked with following the moving POI, as tracking duties can easily be handed off between drones in the fleet 120.

Using the distance and direction of the virtual marker corresponding to the indicated POI relative to the virtual markers corresponding to the fleet 120, the overlay module 134 also may generate an icon or image that is displayed on any suitable display such as the video feeds provided by the fleet 120. The overlay may be an icon that is positioned over the pixels of the video feed that would correspond to the relative direction of the indicated POI, or the overlay may be an image of the indicated POI (e.g., extracted pixels from the original video feed) in the location based on the relative direction. In one example, the overlay module 134 uses ray-tracing to determine the pixels that correspond to the relative distance and direction of the indicated POI, and highlight those pixels accordingly.

The overlay module 134 is also configured to display the overlay on a 2-dimensional map. Using the determined geolocation of the indicated POI, the overlay module positions an icon or image of the indicated POI on the map by correlating the determined geolocation (e.g., GPS coordinates) of the indicated POI to the 2-dimensional map.

The system 100 may further include a server 140 in electronic communication with the virtual positioning system 130 and the user computing device 150. In this example, the server 140 provides a website, data for a mobile application, or other interface through which the user of the user computing device 150 may navigate and otherwise interact with the first drone 110 and/or the fleet 120 (e.g., to pilot the drones, to view video feeds from the drones, etc.). In some examples, the server 140 may receive, in response to a user selection, an indication on the user device 150 of a point-of-interest (POI) on a video feed from one of the drones, and present an overlay on the video feed displayed on the user device 150.

Although a single user device 150 is shown in FIG. 1, it is contemplated that any number of user devices may be included in the system 100, such that the presented overlay may be displayed on video feeds on any number of user devices. For example, each drone in the fleet 120 may be controlled by its own user device, and the drone may in turn provide a video feed to each respective user device. From there, the determined overlay may be displayed on the video feed from each drone onto each user device.

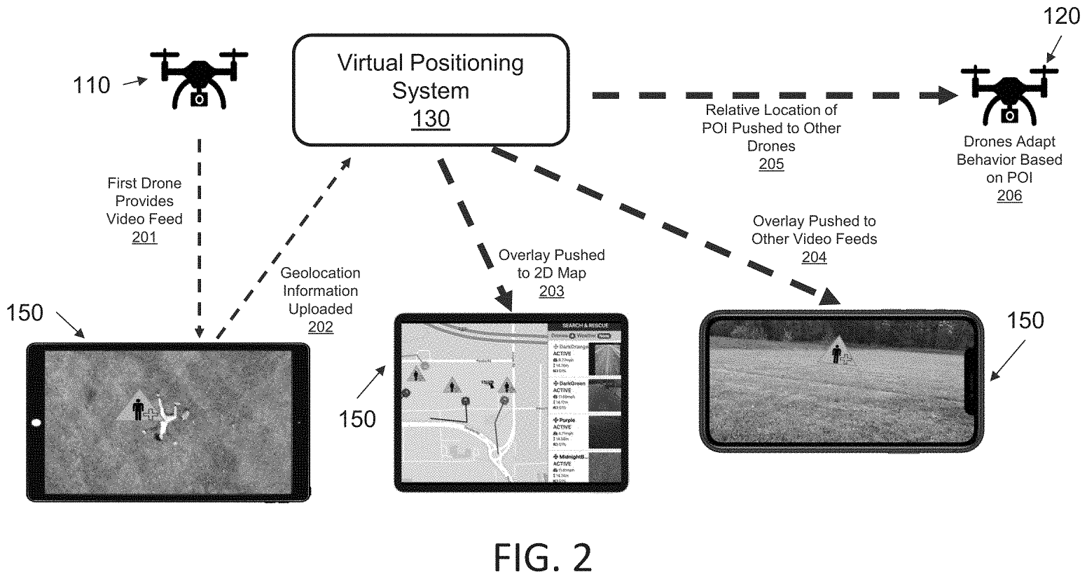

FIG. 2 is a flow chart of an example implementation of the system 100. As shown in FIG. 2, a method 200 of coordinating the location of an indicated POI begins with a step 201, where the first drone 110 provides a video feed to a user device 150. The POI is indicated on the user device 150 and, as discussed above, may be selected by a user or determined by a visual model. At a step 202, the geolocation information for the first drone 110 and the pixel information for the indicated POI are transmitted to the virtual positioning system 130 to be used by the virtual positioning system 130 as disclosed above.

At a step 203, the virtual positioning system 130 pushes the determined overlay to a 2-dimensional map. At a step 204, the virtual positioning system 130 pushes the determined overlay to video feeds from other drones in the fleet 120. The view from the overlaid video feeds may be provided in a first-person view, such that the video feeds may be combined with a visual device (e.g., goggles, glasses, etc.) to provide an AR experience.

At a step 205, the virtual positioning system 130 pushes the relative location of the indicated POI to the fleet 120, In response, the fleet 120 at 206 are controlled based on their relative locations to the indicated POI. For example, if the fleet 120 is not manually piloted (e.g., directly controlled by a user) and is instead controlled autonomously (e.g., the controller 116 receives input from artificial intelligence), the autonomous control may be based on the indicated POI, such that the drones in the fleet 120 are controlled to surround the indicated POI in a particular pattern.

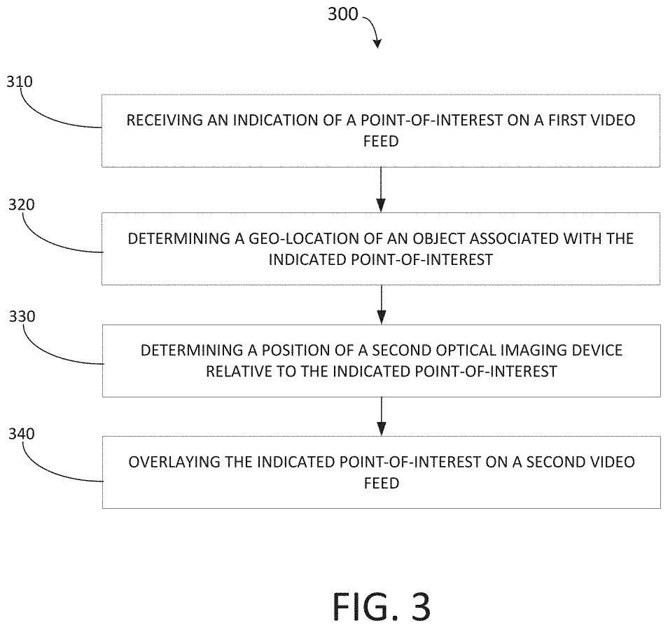

FIG. 3 is a flow chart illustrating an example method 300 of sharing a point-of-interest (POI) across a plurality of video feeds from a plurality of optical imaging devices. The method 300, or one or more portions of the method 300, may be performed by the system 100, and more particularly by the virtual positioning system 130, in some examples.

The method 300 includes, at a step 310, receiving an indication of a POI on a first video feed. As discussed above, the indication may be received via the user device 150 receiving user input. The user input identifies one or more pixels on the first video feed, and the virtual positioning system 130 analyzes the identified pixels to determine an object in the first video feed associated with the identified pixels. This determined object is then treated as the indicated POI. Alternatively, the controller 116 of the first drone 110 that provides the first video feed autonomously determines a POI in the first video feed by analyzing the first video feed using a visual model trained to recognize certain objects as POIs (e.g., people, wrecked cars, etc.)

The method 300 includes, at a step 320, determining a geo-location of an object associated with the indicated POI. First, the geo-location of the optical device (e.g., optical device 112) providing the first video feed is determined and/or received. The geo-location may be of the first drone 110 itself, at which point the geo-location is determined by the positioning device 114 and transmitted to the virtual positioning system 130. If the optical device providing the first video feed is stationary (e.g., a non-moving camera), the geo-location of the optical device may be stored in the virtual positioning system 130. From there, the virtual positioning system 130 uses ray-tracing (or an equivalent technique) to determine a distance and direction of the object associated with the indicated POI relative to the optical device providing the first video feed. By then applying the determined distance and direction to the geo-location of the optical device, the virtual positioning system 130 determines the geo-location of the object associated with the indicated POI.

The method 300 includes, at a step 330, determining a position of a second optical imaging device relative to the indicated POI. The second optical imaging device may be included as a drone in the fleet 120 (e.g., second drone 122A), and is providing a second video feed. Similar to the first optical device, the position of the second optical imaging device may be received from a positioning device included on the second drone 122A, or the location of the second optical imaging device may be stored by the virtual positioning system 130 if the second optical imaging device is stationary. From there, the virtual positioning system 130 determines the direction and distance of the indicated POI relative to the position of the second optical imaging device

The method 300 includes, at a step 340, overlaying the indicated POI on a second video feed from the second optical imaging device. As disclosed above, the overlay module 134 of the virtual positioning system 130 provides an overlay on the video feed, and the overlay may be an icon indicative of a POI (e.g., exclamation point, arrow, etc.) or an image indicative of the indicated POI (e.g., a copy of the one or more pixels of the first video feed that are associated with the indicated POI).

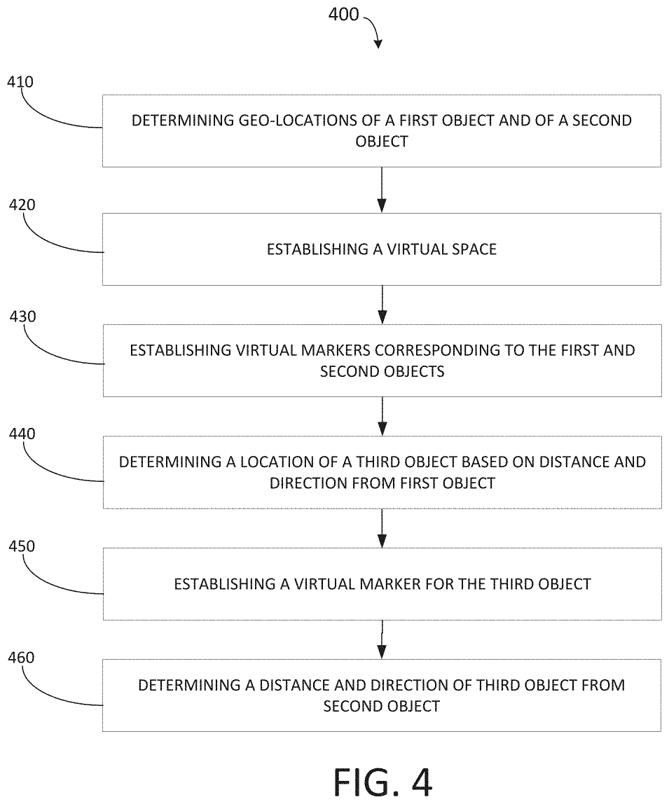

FIG. 4 is a flow chart illustrating an example method 400 of tracking multiple objects in a physical three-dimensional space. The method 400, or one or more portions of the method 400, may be performed by the system 100, and more particularly by the virtual positioning system 130, in some examples.

The method 400 includes, at a step 410, determining geo-locations of a first object and of a second object in the physical space. Each of the first and second object, in one example, are uncrewed aerial vehicles (e.g., drones), such that the first object is the first drone 110 and the second object is the second drone 122A of the fleet 120. As discussed above with reference to steps 320 and 330 of the method 300, the geo-locations of the first and second object may be determined by positioning devices (e.g., positioning device 114) associated with each object and transmitted to the virtual positioning system 130 by controllers (e.g., controller 116) associated with each object.

The method 400 includes, at a step 420, establishing a virtual space. The virtual space may be established to correspond with a defined area in the real-world. As such, the virtual space may include topography associated with the defined area, as well as identified geographic POIs. These geographic POIs could include landmarks, stores, roads, highways, intersections, etc. and may be pulled from a database of geographic POIs and correlated to the defined area. For example, the virtual positioning system 130 may, via the server 140, access a set of stored geographic POIs from an online search engine repository, or the virtual positioning system 130 may have a pre-filled database of stored geographic POIs.

The method 400 includes, at a step 430, establishing virtual markers in the virtual space that correspond to the first object and to the second object. The positions of the virtual markers in the virtual space are based on the geo-locations of the objects in the physical space, such that the relative distances and directions between each virtual marker is identical or equal to the relative distances and directions between each object in the physical space. In this way, relationships between objects in the physical space can be tracked and/or estimated based on defined relationships in the virtual space.

The method 400 includes, at a step 440, determining the location of a third object in the physical space based on a distance and direction from the first object. The third object may be a POI indicated by a user or determined by the virtual positioning system 130, as disclosed above in the step 310 of the method 300. Much like the step 320 of the method 300, the location of third object in the physical space is based on the relative distance and direction from the first optical device, which is determined by the virtual positioning system 130 using ray-tracing, and on the location of the first object

The method 400 includes, at a step 450, establishing a virtual marker in the virtual space for the third object based on the location of the third object in the physical space. Similar to the step 430, the location of the virtual marker in the virtual space corresponds to the physical location of the third object so that the relationship between the third object and any other object is preserved in the virtual space (e.g., the relative distance and direction of the third object's virtual marker to other virtual markers is the same as the relative distance and direction of the third object to other objects in the physical space).

The method 400 includes, at a step 460, determining a distance and direction of the third object from the second object. The virtual positioning system 130 makes this determination based on the distance and direction of the virtual marker associated with the third object from the virtual marker associated with the second object. Once the virtual distance and direction is determined, the virtual positioning system 130 converts that determination to a physical distance and direction. For example, if the virtual space is scaled to be half the size of the physical space, the determined virtual space is scaled appropriately.

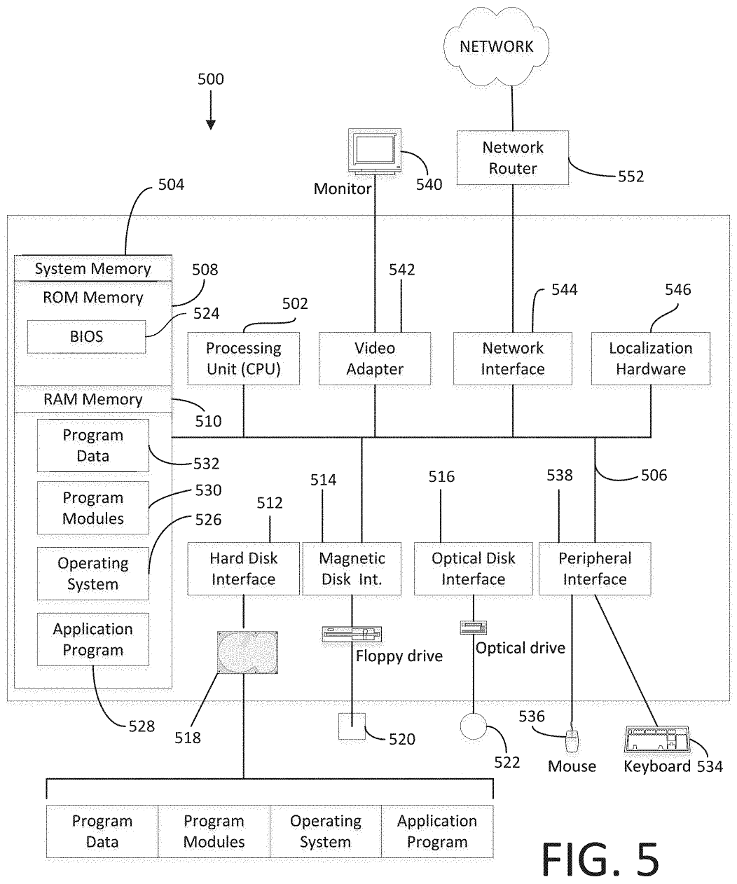

FIG. 5 is a diagrammatic view of an example of a user computing environment that includes a computing system environment 500, such as a desktop computer, laptop, smartphone, tablet, or any other such device having the ability to execute instructions, such as those stored within a non-transient, computer-readable medium. Furthermore, while disclosed and illustrated in the context of a single computing system, those or ordinary skill in the art will also appreciate that the various tasks disclosed hereinafter may be practiced in a distributed environment having multiple computing systems linked via a local or wide-area network in which the executable instructions may be associated with and/or executed by one or more of multiple computing systems.

In its most basic configuration, computing system environment 500 typically includes at least one processing unit 502 and at least one memory 504, which may be linked via a bus. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those of ordinary skill in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard disk 518, and/or peripheral memory devices may be used to store computer executable instructions comprising an operating system 526, one or more applications programs 528 (which may include the functionality of the document recommendation system 130 of FIG. 1 or one or more of its functional modules 506, 508, for example), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 552, that is responsible for network routing. Communications with the network router 552 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 546 for determining a location of the computing system environment 500. In examples, the localization hardware 546 may include, for example only, a GPS antenna, an RFID chip or reader, a WiFi antenna, or other computing hardware that may be used to capture or transmit signals that may be used to determine the location of the computing system environment 500.

The computing environment 500, or portions thereof, may comprise one or more components of the system 100 of FIG. 1, in examples.

While this specification has disclosed certain examples, it will be understood that the claims are not intended to be limited to these examples except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed examples. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These disclosures and representations are the means used by those of ordinary skill in the art of data processing to most effectively convey the substance of their work to others of ordinary skill in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed examples. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present example, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

While this disclosure has described certain examples, it will be understood that the claims are not intended to be limited to these examples except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed examples. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. A method for sharing a point-of-interest across a plurality of video feeds from a plurality of optical imaging devices, the method comprising:
receiving an indication of the point-of-interest associated with a first video feed of the plurality of video feeds, the first video feed provided by a first optical imaging device of the plurality of optical imaging devices;
determining a geo-location of an object associated with the point-of-interest;
determining a position of a second optical imaging device relative to the determined geo-location of the point-of-interest; and
overlaying the point-of-interest on a second video feed, the second video feed provided by the second optical imaging device.

2. The method of claim 1, wherein the plurality of optical imaging devices comprise a plurality of uncrewed aerial vehicles.

3. The method of claim 1, wherein the receiving the indication of the point-of-interest comprises:
displaying the first video feed on a touch-sensitive display;
receiving contact on a portion of the touch-sensitive display; and
determining one or more pixels of the touch-sensitive display corresponding to the received contact.

4. The method of claim 3, further comprising:
analyzing the first video feed to determine an object corresponding to the determined one or more pixels; and
associating the determined object with the point-of-interest.

5. The method of claim 1, wherein the overlaying the point-of-interest on the second video feed comprises rendering, on the second video feed, the object corresponding to the determined one or more pixels.

6. The method of claim 1, wherein the geo-location of the point-of-interest is determined using ray-tracing based on a geo-location of the first optical device.

7. The method of claim 1, wherein the geo-location of the point-of-interest comprises coordinates in a Global Positioning System (GPS).

8. The method of claim 1, wherein the determining the position of the second optical imaging device relative to the determined geo-location of the point-of-interest comprises:
establishing a three-dimensional virtual space; and
setting a plurality of virtual markers in the virtual space, the plurality of virtual markers comprising:
a first virtual marker corresponding to the first optical imaging device;
a second virtual marker corresponding to the second optical imaging device; and
a third virtual marker corresponding to the object associated with the point-of-interest,
wherein:
a position of each of the plurality of virtual markers within the virtual space is based on a geo-location of the corresponding at least one device or object, and
the determined position of the second optical imaging device relative to the determined geo-location of the point-of-interest is based on a position of the second virtual marker relative to the third virtual marker.

9. The method of claim 8, wherein the positions of the first virtual marker and the second virtual marker are updated at least once per second based on movement of the first optical device and the second optical device.

10. A method for tracking multiple objects in a physical three-dimensional space, the method comprising:
determining a first geo-location of a first object and a second geo-location of a second object;
establishing a virtual space corresponding to the physical three-dimensional space;
establishing, in the virtual space, a first virtual marker corresponding to the first object, a first position of the first virtual marker based on the first geo-location;
establishing, in the virtual space, a second virtual marker corresponding to the first object, a first position of the first virtual marker based on the first geo-location;
determining a third location of a third object in the physical three-dimensional space based on a distance of the third object from the first object;
establishing, in the virtual space, a third virtual marker corresponding to the third location; and
determining a distance and a direction of the third object from the second object based on a distance and a direction of the third virtual marker from the second virtual marker.

11. The method of claim 10, wherein the first object and the second object each comprise an uncrewed aerial device.

12. The method of claim 11, wherein determining the third location of the third object comprises:
receiving an indication on a video feed provided by an optical imaging device of the first object;
determining one or more pixels of the video corresponding to the received indication;
analyzing the video feed to determine an object corresponding to the determined one or more pixels;
determining a geo-location of the object using ray-tracing based on the first location of the first object; and
setting the determined geo-location as the third location.

13. The method of claim 10, wherein:
at least one of the first object or the second object is capable of movement, and
at least one of the first position of the first virtual marker or the second position of the second virtual marker is updated at least once per second based on movement of the first object or the second object.

14. The method of claim 10, further comprising:
receiving, from the second object, a video feed; and
overlaying the third object on the video feed based on the determined distance and direction of the third object from the second object.

15. A system for sharing a point-of-interest across a plurality of video feeds from a plurality of optical imaging devices, the system comprising:
a processor; and
a non-transitory computer-readable medium having stored thereon instructions that are executable by the processor to cause the system to perform operations comprising:
receiving an indication of the point-of-interest associated with a first video feed of the plurality of video feeds, the first video feed provided by a first optical imaging device of the plurality of optical imaging devices;
determining a geo-location of an object associated the point-of-interest;
determining a position of a second optical imaging device relative to the determined geo-location of the point-of-interest; and
overlaying the point-of-interest on a second video feed, the second video feed provided by the second optical imaging device.

16. The system of claim 15, wherein the plurality of optical imaging devices comprise a plurality of uncrewed aerial vehicles.

17. The system of claim 15, wherein the receiving the indication of the point-of-interest comprises:
displaying the first video feed on a touch-sensitive display;
receiving contact on a portion of the touch-sensitive display;
determining one or more pixels of the touch-sensitive display corresponding to the received contact;
analyzing the first video feed to determine an object corresponding to the determined one or more pixels; and
associating the determined object with the point-of-interest.

18. The system of claim 15, wherein the overlaying the point-of-interest on the second video feed comprises rendering, on the second video feed, the object corresponding to the determined one or more pixels.

19. The system of claim 15, wherein the determining the position of the second optical imaging device relative to the determined geo-location of the point-of-interest comprises:
establishing a three-dimensional virtual space; and
setting a plurality of virtual markers in the virtual space, the plurality of virtual markers comprising:
a first virtual marker corresponding to the first optical imaging device;
a second virtual marker corresponding to the second optical imaging device; and
a third virtual marker corresponding to the object associated with the point-of-interest,
wherein:
a position of each of the plurality of virtual markers within the virtual space is based on a geo-location of the corresponding device or object, and
the determined position of the second optical imaging device relative to the determined geo-location of the point-of-interest is based on a position of the second virtual marker relative to the third virtual marker.

20. The system of claim 19, wherein the positions of the first virtual marker and the second virtual marker are updated at least once per second based on movement of the first optical device and the second optical device.
